(19) United States
(12) Patent Application Publication
(10) Pub. No.: US 2020/0327044 A1
(43) Pub. Date: Oct. 15, 2020

(54) METHOD FOR CONSTRUCTING TEST SCENARIO AND INFORMATION PROCESSING DEVICE

(71) Applicant: FUJITSU LIMITED, Kawasaki-shi (JP)

(72) Inventors: Bingfeng PI, Beijing (CN); Shenbin ZHANG, Beijing (CN); Ence ZHOU, Beijing (CN); Song HUA, Beijing (CN); Haoli SUN, Beijing (CN); Jun SUN, Beijing (CN)

(73) Assignee: FUJITSU LIMITED, Kawasaki-shi (JP)

(21) Appl. No.: 16/845,660

(22) Filed: Apr. 10, 2020

(30) Foreign Application Priority Data
Apr. 15, 2019 (CN) 201910299220.1

(51) Int. Cl. G06F 11/36

(52) U.S. Cl. CPC G06F 11/3684

(57) ABSTRACT

A method for a computer to construct a test scenario and an information processing device are provided. The method for constructing a test scenario for a target application executed through a plurality of executable applications in distributed nodes in an asynchronous manner includes constructing an invocation relationship graph representing a plurality of functions included in the executable applications; determining, according to a code structure of each of the functions in the invocation relationship graph, one or more of a plurality of risk types which may cause an operation error for the function; traversing the invocation relationship graph to obtain possible function paths and determining, based on a plurality of risk types of functions in each of the possible function paths, risk types of the function path; and determining, according to the risk types of the function path, a type of a test scenario for the function path.

The present application claims priority to Chinese Patent Application No. 201910299220.1, titled “METHOD FOR CONSTRUCTING TEST SCENARIO AND INFORMATION PROCESSING DEVICE”, filed on Apr. 15, 2019 with the Chinese Patent Office, which is incorporated herein by reference in its entirety.

### FIELD

The present disclosure generally relates to the field of application testing, and in particular to a method for constructing a test scenario for an application which is executed in a decentralized manner and an information processing device capable of implementing the method.

### BACKGROUND

In recent days, applications such as blockchains that are executed asynchronously in a decentralized manner gain more and more attention. Previously, execution of traditional applications relies on a central authority, while applications executed asynchronously in the decentralized manner do not require a central authority to perform corresponding functions. Therefore, a network framework that does not require trust is provided, and network users can execute applications without trust.

Since applications executed asynchronously in the decentralized manner may be executed on multiple different nodes, consistency of execution is very important. Accordingly, it is required to confirm that an application is correct internally before executing the application, so as to avoid risk vulnerability.

Therefore, it is desirable to provide a method capable of constructing an appropriate test scenario for an application which is executed asynchronously in a decentralized manner, so as to avoid risk vulnerability in the application through testing.

### SUMMARY

A brief summary of the present disclosure is given in the following, so as to provide basic understanding on some aspects of the present disclosure. It should be understood that, the summary is not an exhaustive summary of the present disclosure. The summary is neither intended to determine key or important parts of the present disclosure, nor intended to limit the scope of the present disclosure. An object of the summary is to provide some concepts in a simplified form, as preamble of a detailed description later.

In view of need for a method for constructing a test scenario for an application which is executed asynchronously in a decentralized manner, one of objects of the present disclosure is to provide a method for constructing a test scenario and an information processing device capable of implementing the method, which can be used for constructing an appropriate test scenario for a target application which is executed through a plurality of executable applications in distributed nodes in an asynchronous manner.

A method for a computer to construct a test scenario for a target application is provided according to an aspect of the present disclosure, wherein the target application is executed through a plurality of executable applications in distributed nodes in an asynchronous manner. The method includes: constructing an invocation relationship graph representing a plurality of functions included in the plurality of executable applications; determining, according to a code structure of each function of the plurality of functions in the invocation relationship graph, one or more of a plurality of risk types which may cause an operation error for the function; traversing the invocation relationship graph to obtain possible function paths among the functions and determining, based on a plurality of risk types of functions in each function path of the possible function paths, risk types of the function path; and determining, according to the risk types of the function path, a type of a test scenario for the function path.

An information processing device is provided according to another aspect of the present disclosure. The information processing device includes a processor. The processor is configured to: construct an invocation relationship graph representing a plurality of functions included in a plurality of executable applications for a target application, wherein the target application is executed through the plurality of executable applications in distributed nodes in an asynchronous manner; determine, according to a code structure of each function of the plurality of functions in the invocation relationship graph, one or more of a plurality of risk types which may cause an operation error for the function; traverse the invocation relationship graph to obtain possible function paths among the functions and determine, based on a plurality of risk types of functions in each function path of the possible function paths, risk types of the function path; and determine, according to the risk types of the function path, a type of a test scenario for the function path.

A program that causes a computer to implement the above method for constructing a test scenario is further provided according to another aspect of the present disclosure.

A corresponding storage medium is further provided according to another aspect of the present disclosure. The storage medium stores a machine-readable instruction code that, when being read and executed by a machine, causes the machine to perform the above method for constructing a test scenario.

According to the aspects of embodiments of the present disclosure, at least the following benefits can be obtained. With the method for constructing a test scenario, the information processing device, the program, and the storage medium according to the present disclosure, an appropriate test scenario can be constructed for an application which is executed asynchronously in a decentralized manner, so as to effectively detect possible risks in the application.

These and other advantages of the present disclosure are more apparent through the following detailed description of preferred embodiments of the present disclosure with reference to the accompanying drawings.

### BRIEF DESCRIPTION OF THE DRAWINGS

The present disclosure can be better understood by referring to the detailed description given below in conjunction with the drawings. In the drawings, same or similar reference numerals are used to represent same or similar components. The drawings, together with the following detailed description, are incorporated in and form a part of this specification to further illustrate preferred embodiments of the present disclosure and explain principles and advantages of the present disclosure. In the drawings:

FIG. 1 is a flowchart showing an example flow of a method for constructing a test scenario according to an embodiment of the present disclosure;

FIG. 2 is an explanatory diagram for explaining an example in which the method shown in FIG. 1 is applied for constructing a test scenario for an application;

FIG. 3 is a schematic diagram showing four types of test scenarios;

FIG. 4 schematically shows a framework of a Hyperledger Fabric in a blockchain;

FIG. 5 shows an example of a risk that may be caused by a function including an operation of reading a variable written by the function itself;

FIG. 6 shows an example of a risk that may be caused by a function including an operation of writing after reading;

FIG. 7 shows an example of a risk that may be caused by a function including a write operation only;

FIG. 8 is a schematic block diagram showing an example structure of an information processing apparatus according to an embodiment of the present disclosure; and

FIG. 9 is a structural diagram showing a possible hardware configuration that may be used for implementing the method for constructing a test scenario, the information processing apparatus, and the information processing device according to the embodiments of the present disclosure.

### DETAILED DESCRIPTION OF EMBODIMENTS

Exemplary embodiments of the present disclosure are described below with reference to the drawings. For clarity and conciseness, not all characteristics of an actual embodiment are described in the specification. However, it should be understood that many embodiment-specific decisions, for example, conforming to restrictions related to system and business, must be made when developing any actual embodiment, so as to achieve a specific goal of a developer. These restrictions may vary depending on embodiments. In addition, it should be understood that, although development work may be complex and time-consuming, the development work is merely a routine task for those skilled in the art who benefit from the present disclosure.

Here, it should be further noted that, in order to avoid obscuring the present disclosure due to unnecessary details, the drawings show only apparatus structures and/or processing steps that are closely related to technical solutions of the present disclosure, and other details have little relevance to the present disclosure are omitted.

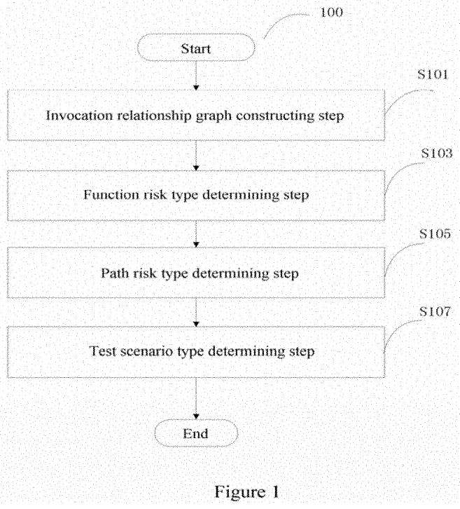

A method for constructing a test scenario is provided according to an aspect of the present disclosure. FIG. 1 is a flowchart showing an example flow of a method 100 for constructing a test scenario according to an embodiment of the present disclosure.

The method 100 for constructing a test scenario according to this embodiment is capable of constructing a test scenario for a target application which is executed through a plurality of executable applications in distributed nodes in an asynchronous manner. As shown in

FIG. 1, the method 100 may include steps S101, S103, S105 and S107. In step S101, an invocation relationship graph for functions included in the plurality of executable applications is constructed. In step S103, according to a code structure of each function in the invocation relationship graph, one or more of a plurality of risk types which may cause an operation error are determined for the function. In step S105, the invocation relationship graph is traversed to obtain all possible function paths, and risk types of each function path are determined based on risk types of functions in the function path. In step 5107, according to risk types of each function path, a type of a test scenario for the function path is determined.

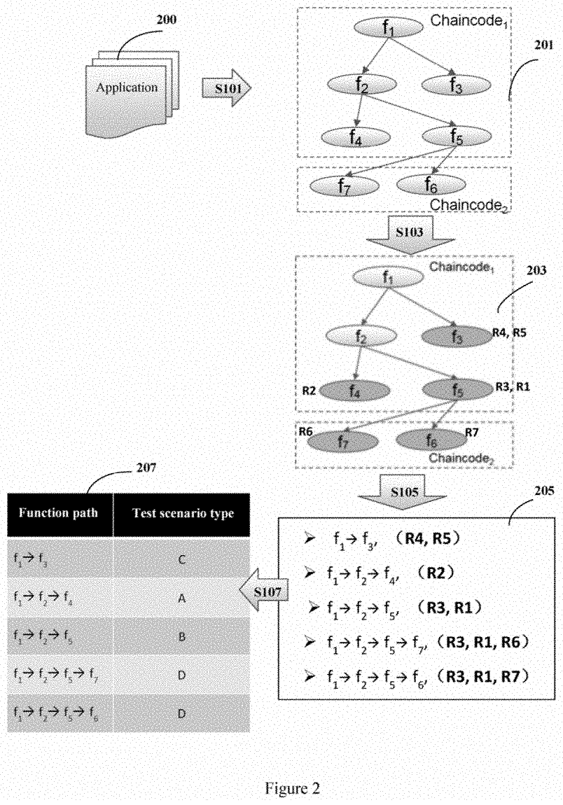

Exemplary processing in each step of the method 100 is briefly described below with reference to FIG. 2, which is an explanatory diagram for explaining an example in which the method 100 shown in FIG. 1 is applied for constructing a test scenario for a target application (or for one or more executable applications of the target application). As shown in FIG. 2, for a target application 200 executable by way of a plurality of executing applications asynchronously in parallel, in step S101, for example, an invocation relationship graph 201 for functions included in two executable applications (namely, Chaincode1 and Chaincode2) included in the target application 200 is obtained through semantic analysis, parsing and the like. In an example, the target application 200 may include executable applications such as smart contracts in a blockchain written in GO language. In step S101, the smart contracts may be parsed into an abstract syntax (AST) tree by a GO language parser and the like. Then, functions f1 to f7 and invocation relationships among these functions are extracted from the AST tree by an AST parser, thereby obtaining the invocation relationship graph 201.

Next, in step S103, according to the code structure of each function in the invocation relationship graph 201, one or more of a plurality of risk types R1 to R7 which may cause an operation error are determined for the function, thereby obtaining an invocation relationship graph 203 labeled with risk types. In this example, as shown in the invocation relationship graph 203, functions f₁ and f₂ involve no risk that may cause the operation error. Functions f₃ to f₇ are each associated with one or more of the plurality of risk types R1 to R7. The plurality of risk types R1 to R7 as examples may be predefined herein. For example, a risk type of each function may be determined depending on a code language of the function, an invocation relationship with other functions and the like. A correspondence between these risk types and functions is described later with examples.

After each function is labeled with its risk type as described above, in step S105, all possible function paths in the invocation relationship graph 203 are traversed in manners such as depth-first traversal or breadth-first traversal. Breadth-first traversal is taken as an example, and the following function paths may be obtained from the invocation relationship graph 203: {f₁; f₁→f2; f₁→f3; f₁→f₂→f₄; f₁→f₂→f₅; f₁→f₂→f₅→f₇; f₁→f₂→f₅→f₆}. Then, for the above function paths, based on risk types of functions in each function path, risk types of the function path are determined. That is, a set of risk types of functions in the function path is determined, so as to obtain risk types of each function path as shown in a chart 205. It should be noted that among all function paths traversed from the invocation relationship graph 203, function paths {f₁; f₁→f₂} do not include any risk function. Therefore, these function paths are not included in the chart 205.

Next, in step S107, according to the risk types of each function path shown in the chart 205, types A to D of test scenarios for respective function paths are determined. That is, a correspondence between the function paths and types of test scenarios as shown in a table 207 is obtained. The types A to D of test scenarios as examples may be predefined and are appropriately set based on various factors such as a code structure and a manner of executing a to-be-tested application, so as to detect various risk types of each function path in the application.

In a preferred embodiment, the types of test scenarios may include: a test scenario simulating execution of the application (one or more of the executable applications of the application) on one node for one time (type A), a test scenario simulating execution of concurrent operations by multiple users on the application (one or more of the executable applications of the application) on one node (type B), a test scenario simulating simultaneous execution of the application (one or more of the executable applications of the application) on multiple nodes for one time (type C) and a test scenario simulating execution of concurrent operations by multiple users on the application (one or more of the executable applications of the application) on multiple nodes (type D).

Setting of the above four risk types in this preferred embodiment is particularly beneficial for constructing a test scenario for a target application which is executed through a plurality of executable applications in distributed nodes in an asynchronous manner.

In a traditional application executed through a central authority, accuracy of code is checked by performing unit testing on a single user operation for the central authority (central node). However, in a target application which is executed through a plurality of executable applications in distributed nodes in an asynchronous manner, there may be an intermediate step between the execution of the application (one or more of the executable applications) on each node and confirmation or writing of a final result. Therefore, all risks that may exist in the application cannot be ensured to be tested by only performing the unit testing on a single user operation for a single node.

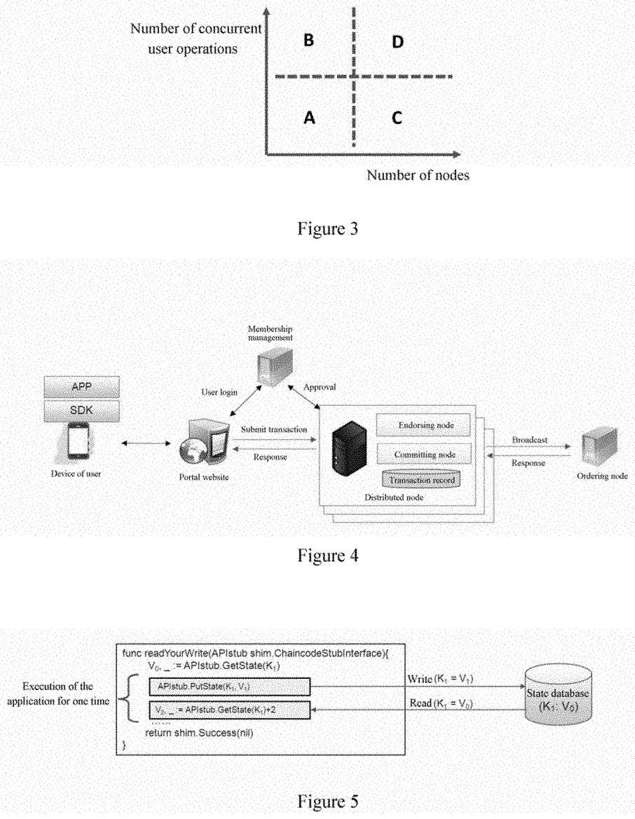

Accordingly, in this preferred embodiment, four types A to D of test scenario are constructed. Different numbers of nodes (a single node; and multiple nodes) and different numbers of concurrent user operations (operation by only one user, which may also be referred to as execution of the application (one or more of the executable applications) for one time; and concurrent operations by multiple users) are set, so that test scenarios capable of detecting corresponding risks can be appropriately set for different risk types of each function path. FIG. 3 is a schematic diagram showing four types A to D of test scenarios. A horizontal axis represents the number of nodes required for a test scenario. A vertical axis represents the number of concurrent user operations required for the test scenario.

With the above method for constructing a test scenario according to this embodiment, a type of a test scenario for each function path included in an application can be determined according to risk types of functions in the function path, thereby determining an appropriate test scenario for the entire application (that is, all possible function paths in the invocation relationship graph for functions included in the target application), so that effective testing can be performed for all risks that the application may involve.

In an example, the application targeted by the method for constructing a test scenario according to this embodiment described above with reference to FIGS. 1 to 3 may include smart contracts in a blockchain, and the plurality of distributed nodes through which the application is executed in an asynchronous manner may be a plurality of endorsing nodes in the blockchain. For example, the blockchain may include a Hyperledger Fabric.

For ease of description, details of preferred embodiments of the present disclosure are described below in combination with examples of the smart contracts. Based on the present disclosure, those skilled in the art can understand that the embodiments of the present disclosure may be appropriately applied to various applications that are executed asynchronously through a plurality of distributed nodes in addition to the smart contract in the blockchain, which is not described in detail herein.

Here, first, the Hyperledger Fabric in the blockchain as an example of the application executed through a plurality of distributed nodes in an asynchronous manner in this embodiment is briefly described with reference to FIG. 4.

As shown in FIG. 4, an application based on a Hyperledger is executed asynchronously in parallel on a plurality of distributed nodes. Execution results are stored in a blockchain (Hyperledger) which serves as a distributed database. The Hyperledger Fabric includes three most important components, namely, an endorsing node, an ordering node (or ordering service), and a committing node. A smart contract (which is also referred to as a chaincode) is resided on a plurality of endorsing nodes. A user may trigger an invocation of a Software Development Kit (SDK) through an APP application, so as to trigger execution of the smart contract on the endorsing node. The endorsing node packs the execution results into a read/write set (where executing a smart contract for one time to obtain a corresponding to-be-confirmed execution result, that is, the read/write set, may be referred to as a “transaction” in the art, which may be used without confusion for those skilled in the art hereinafter), and returns the transaction to a device of user (a client) after verifying legality of transaction information and signing the transaction information.

Next, after receiving a verification reply from the endorsing node, the device of user confirms that the verification is successful. After the verification is successfully completed, the device of user may transmit the signed transaction information to the ordering node. The ordering node orders the transaction information based on a certain consensus, packs the ordered transaction information into a block, and transmits the block to the committing node. For the received transaction information, the committing node determines whether an execution result of the application is correct depending on a specific endorsing policy, and signs confirmed transaction information. Regardless of whether the execution result of the application is correct, the ordered and packed transaction information block is written by the committing node into the blockchain, so that a ledger status on multiple nodes can be synchronized. After acquiring confirmation from the committing node that the packed block is written into the ledger, the operation by the user is finally completed.

As described above, in the Hyperledger Fabric as an example of an application which is executed asynchronously in a decentralized manner, there are several intermediate steps between the step of executing the smart contract by the endorsing node and the step of finally writing the execution result of the smart contract to the Hyperledger by the committing node. That is, these two steps are performed asynchronously. Therefore, when constructing a test scenario, the four types described above with reference to FIG. 3 may be considered, so as to fully detect various risks faced when executing the application by the distributed nodes asynchronously.

In the following, in combination with the Hyperledger Fabric shown in FIG. 4, examples of risk types in each preferred embodiment and the correspondence between these risk types and types of test scenarios are described based on the embodiments described with reference to FIGS. 1 to 3. Specifically, a plurality of risk types R1 to R7 that may be involved in an application such as the Hyperledger Fabric in a blockchain are described together with properly determined types A to D of test scenarios corresponding to these risk types.

R1 represents a risk of calling a function in another smart contract.

In an example, when the invocation relationship graph for functions included in the application is constructed, for example, in step S101 as shown in FIG. 1, an invocation relationship graph for functions included in smart contracts of an entire blockchain may be constructed. Referring to the example in FIG. 2, an overall invocation relationship graph 201 is constructed for two smart contracts Chaincode1 and Chaincode2. In this case, a function in one smart contract may call a function in another smart contract (such as using a code

APlstub.invokeChaincode( ) in the GO language), which causes a possibility that the function in one smart contract may modify a status of a database (for example, the Hyperledger) of another smart contract. Therefore, a function including this kind of invocation may result in insecurity. The risk of a function calling a function in another smart contract is defined as a risk type Rl.

Accordingly, when the risk type is determined for the function in the invocation relationship graph 201 according to the code structure of the function, for example, in step S103 as shown in FIG. 1, the plurality of risk types to be considered may include the risk of a function calling a function in another smart contract (that is, a risk type R1).

It is found that, for the risk type R1, an error can be detected by executing a smart contract for one time (a single transaction) on a single endorsing node. Therefore, in a preferred embodiment, a type of a test scenario determined with respect to the risk type R1 of a function calling a function in another smart contract may include a test scenario simulating execution of the smart contract on one endorsing node for one time, that is, a type A shown in FIG. 3.

R2 represents a risk of a function reading a variable written by the function itself.

FIG. 5 shows an example of a risk that may be caused by a part of code in a function including an operation of reading a variable written by the function itself. As shown in FIG. 5, due to asynchronization between execution of a write operation of a smart contract (for example, via an endorsing node in FIG. 4) and an operation that the execution result is written into a database (state database) (for example, via a committing node in FIG. 4) in a blockchain such as the Hyperledger, a value Vi cannot be immediately updated to a distributed database (such as the Hyperledger) of the blockchain by performing an operation of writing the value Vi to a variable K1 (such as using a code APlstub.PutState (K, V) in the GO language). The variable K1 still remains at a value VO. Therefore, the newly written value Vi cannot be immediately used in a read operation (such as using a code APlstub.GetState (K) in the GO language) in the same execution of the application (for example, the same transaction in the blockchain). If a value of this variable is used, all subsequent business logic may fail. Therefore, a function including this kind of operation may result in insecurity. The risk of a function including an operation of reading a variable written by the function itself is defined as a risk type R2.

Accordingly, when the risk type is determined for the function in the invocation relationship graph 201 according to the code structure of the function, for example, in step S103 as shown in FIG. 1, the plurality of risk types to be considered may include the risk of a function including an operation of reading a variable written by the function itself (that is, the risk type R2).

It is found that, for the risk type R2, similar to the risk type R1, an error can be detected by executing an application (one or more of the executable applications) or a smart contract for one time (a single transaction) on a single endorsing node. Therefore, in a preferred embodiment, a type of a test scenario determined with respect to the risk type R2 of a function reading a variable written by the function itself may include a test scenario simulating execution of the smart contract on one endorsing node for one time, that is, the type A shown in FIG. 3.

R3 represents a risk of a function including an operation of updating, in a batch processing manner, values of a plurality of variables that are obtained through a query.

It is found that in an application such as the Hyperledger in a blockchain, if a function includes an operation of updating values of a plurality of variables that are obtained through an operation of query range after the operation of range query (such as using a code

APlstub.GetQueryResult( ) in the GO language), a updated result may be inconsistent with a latest value of the corresponding variable. Due to characteristics of asynchronous execution of the smart contract, values of queried variables may be changed by other transactions by other users, during a process of updating the values of the queried variables. Therefore, a function including this kind of operation may result in insecurity. The risk of a function including an operation of updating, in a batch processing manner, values of a plurality of variables that are obtained through a query is defined as a risk type R3.

Accordingly, when the risk type is determined for the function in the invocation relationship graph 201 according to the code structure of the function, for example, in step S103 as shown in FIG. 1, the plurality of risk types to be considered may include the risk of a function including an operation of updating, in a batch processing manner, values of a plurality of variables that are obtained through a query (that is, the risk type R3).

For the risk type R3 that the function includes the above operation, performance of the function in a case of concurrent transactions is required to be considered. Accordingly, in a preferred embodiment, a type of a test scenario determined with respect to the risk type R3 may include a test scenario simulating execution of concurrent operations by multiple users on the application (one or more of the executable applications) on one node, that is, a type B shown in FIG. 3.

R4 represents a risk of a function including an operation that generates an uncertain result.

In an example, the operation that generates an uncertain result may include operations such as random number generation, a temporary value of a node, and key-value pair structure traversal (such as Hashmap, Hashtable). If functions in the application (one or more of the executable applications) or the smart contract include any one of the above operations that generate an uncertain result, execution of these functions on multiple different endorsing nodes may result in different results, resulting in inconsistence of execution results among multiple nodes. Therefore, a function including this kind of operation may result in insecurity. The risk of a function including an operation that generates an uncertain result is defined as a risk type R4.

Accordingly, when the risk type is determined for the function in the invocation relationship graph 201 according to the code structure of the function, for example, in step S103 as shown in FIG. 1, the plurality of risk types to be considered may include the risk of a function including an operation that generates an uncertain result (that is, the risk type R4).

For a function involving the risk type R4, performance of the function executed on multiple nodes is required to be considered. Therefore, in a preferred embodiment, a type of a test scenario determined with respect to the risk type R4 may include a test scenario simulating simultaneous execution of the application (one or more of the executable applications) on multiple nodes for one time, that is, a type C shown in FIG. 3.

R5 represents a risk of a function including an operation that calls external resources

In an example, the operation that calls external resources may include, for example,

Web service calling (http://xxx), external library calling, system command line calling. If a function in the application (one or more of the executable applications) or the smart contract includes any one of the above operations that calls external resources, execution of the function on multiple different nodes may result in different results. Therefore, a function including this kind of operation may result in insecurity. The risk of a function including an operation that calls external resources is defined as a risk type R5.

Accordingly, when the risk type is determined for the function in the invocation relationship graph 201 according to the code structure of the function, for example, in step S103 as shown in FIG. 1, the plurality of risk types to be considered may include the risk of a function including an operation that calls external resources (that is, the risk type R5).

For a function involving the risk type R5, performance of the function executed on multiple nodes is required to be considered. Therefore, in a preferred embodiment, a type of a test scenario determined with respect to the risk type R5 may include a test scenario simulating simultaneous execution of the application (one or more of the executable applications) on multiple nodes for one time, that is, a type C shown in FIG. 3.

In addition, optionally, in an application example of a smart contract involving a blockchain, such as the Hyperledger shown in FIG. 4, in a test scenario of simulating simultaneous execution of the application (one or more of the executable applications) on multiple nodes for one time (for example, in the type C of the test scenario determined with respect to the described risk types R4 and R5, as shown in FIG. 3), a endorsing policy of each endorsing node may be defined. More specifically, a plurality of endorsing nodes may first simultaneously execute the smart contract with a first endorsing policy for one time, and then simultaneously execute the smart contract with a second endorsing policy for one time.

In an example, the first endorsing policy and the second endorsing policy may be any two of the following endorsing policies: an endorsing policy of “AND”, an endorsing policy of “OR”, and an endorsing policy of “M of N”. The endorsing policy of “AND” indicates that it is required to only confirm that the execution results on a plurality of endorsing nodes are consistent and these endorsing nodes all perform signature endorsing, so that the committing node finally confirms the transaction and signs the transaction. The endorsing policy of “OR” indicates that it is required to confirm that any one of the plurality of endorsing nodes performs the signature endorsing, so that the committing node confirms the transaction and signs the transaction. The endorsing policy of “M of N” (where M and N are natural numbers and M is less than N) indicates that it is required to confirm that the execution results of any M endorsing nodes among the N endorsing nodes are consistent and the M endorsing nodes all perform the signature endorsing, so that the committing node finally confirms the transaction and signs the transaction. It is expected that no matter what endorsing policy, the same results can be obtained by executing the smart contract through the plurality of endorsing nodes.

R6 and R7 represent a risk of a function including a write operation on a distributed database.

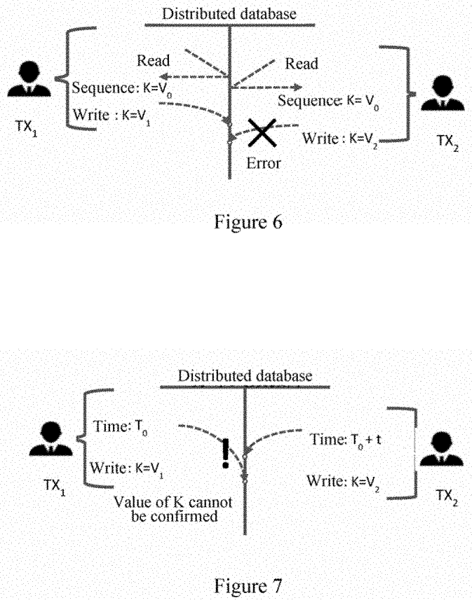

In an example, the case of a function including a write operation on a distributed database may be a case of the function including an operation of writing after reading. FIG. 6 shows an example of an error that occurs in this case. Referring to FIG. 6, two users execute an executable application at the same time (or approximately at the same time). For example, in the case of a Hyperledger, the two users submit transactions TX₁ and TX₂ respectively. The two transactions operate one variable K. Between a read operation and a write operation of the transaction TX₂, the transaction TX₁ updates a value of the variable K to Vi. In this way, a read-write conflict occurs, an update operation or a write operation of the transaction TX₂ may fail. Therefore, a function including this kind of operation may result in insecurity. The risk of a function including an operation of writing after reading is defined as a risk type R6.

In addition, the case of a function including a write operation on a distributed database may be a case of the function including a write operation only. FIG. 7 shows an example of an error that occurs in this case. Two users execute the executable application at the same time (or approximately the same time). For example, in the case of a Hyperledger, the two users submit transactions TX₁ and TX₂ at the same time (or approximately the same time), respectively. These two transactions operate one variable K, resulting in that a status of the distributed database cannot be ensured. Although the transaction TX₁ with a submission time of T₀ is submitted before the transaction TX₂ with a submission time of (T₀+t), the two transactions are required to be endorsed and ordered on a distributed nodes before being written into the distributed database. Therefore, a time sequence when the transaction results are eventually written to the Hyperledger as a distributed database cannot be ensured, which may cause the transaction TX₁ to be written into the Hyperledger after the transaction TX₂. In this way, the value of the variable K is finally determined by the transaction TX₁, rather than the transaction TX₂ as expected. Therefore, a function including this kind of operation may result in insecurity. The risk of a function including just a write operation is defined as a risk type R7.

Accordingly, when the risk type is determined for the function in the invocation relationship graph 201 according to the code structure of the function, for example, in step S103 as shown in FIG. 1, the plurality of risk types to be considered may include the risk of a function including a write operation on a distributed database (that is, the risk types R6 and R7).

It is found that for functions involving the above two risk types R6 and R7, it is best to test consistency of execution results of the functions on a plurality of endorsing nodes in a case of multiple concurrent transactions. Therefore, in a preferred embodiment, with the risk types R6 and R7 that the function includes a write operation on the distributed database, a test scenario of simulating the execution of concurrent operations by multiple users on the application (one or more of the executable applications) on multiple nodes is determined, that is, a type D as shown in Figure3 is determined, so that a risk of read-write conflict or write conflict that possibly exists in the above functions can be detected.

Optionally, in an application example of a smart contract involving a blockchain, such as the Hyperledger shown in FIG. 4, in the test scenario of simulating the execution of concurrent operations by multiple users on the application (one or more of the executable applications) on multiple nodes (for example, the type D of the test scenario determined with respect to the above risk types R6 and R7 as shown in FIG. 3), the multiple nodes may involve different network latencies.

In an example, among a plurality of endorsing nodes used to execute smart contracts, some endorsing nodes may involve no network latency, some endorsing nodes may involve a network latency of 5 milliseconds, and other endorsing nodes may involve a network latency of 10 milliseconds. In this way, performance of endorsing nodes under different network latencies can be tested, and it is expected to obtain consistent results regardless of the network latency.

Various example risk types R1 to R7, which may be applied to an application such as the Hyperledger that is executed through a plurality of distributed nodes in an asynchronous manner, are described above. Preferred embodiments of types A to D of the test scenario corresponding to these risk types are also described. In combination with these examples and preferred embodiments, reference is made back to the example shown in FIG. 2.

For example, as shown in a first line of the chart 205 in FIG. 2, the risk types (R4 and R5) are determined for the function paths f₁→f₃. As described above, for each of the risk types R4 and R5, simultaneous execution of the application (one or more of the executable applications) on multiple nodes for one time is required to be simulated, that is, the type C of the test scenario shown in FIG. 3 is required. Therefore, as shown in a table 207 in FIG. 2, the type C of the test scenario is determined for the function path f₁→f₃. In this way, types of the test scenario shown in table 207 in FIG. 2 is determined based on the risk types of each function path, which is not described in detail herein.

Exemplary flows of a method for constructing a test scenario according to the present disclosure are described above with reference to FIGS. 1 to 7. As described above, with the method for constructing a test scenario in this embodiment, an appropriate test scenario can be constructed for a target application which is executed through a plurality of executable applications in distributed nodes in an asynchronous manner, so as to effectively detect possible risks in the application. Particularly, for an application example of a smart contract in a blockchain such as a Hyperledger, with the method according to the preferred embodiments of the present disclosure, risk types that may exist in the application can be effectively detected, and a type of the test scenario corresponding to each risk type can be appropriately determined, so as to achieve a good balance between test efficiency and test accuracy.

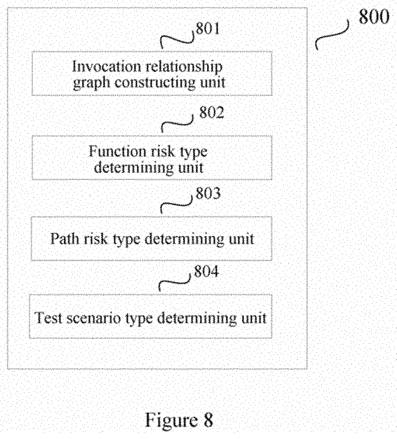

An information processing apparatus is provided according to another aspect of the present disclosure. FIG. 8 is a schematic block diagram showing an example structure of an information processing apparatus according to an embodiment of the present disclosure.

An information processing apparatus 800 may construct a test scenario for a target application which is executed through a plurality of executable applications in distributed nodes in an asynchronous manner. As shown in FIG. 8, the information processing apparatus 800 may include an invocation relationship graph constructing unit 801, a function risk type determining unit 802, a path risk type determining unit 803 and a test scenario type determining unit 804. The invocation relationship graph constructing unit 801 is configured to construct an invocation relationship graph for functions included in the plurality of executable applications. The function risk type determining unit 802 is configured to determine, according to a code structure of each function in the invocation relationship graph, one or more of a plurality of risk types which may cause an operation error, for the function. The path risk type determining unit 803 is configured to traverse the invocation relationship graph to obtain all possible function paths and determine, based on risk types of functions in each function path, risk types of the function path. The test scenario type determining unit 804 is configured to determine, according to risk types of each function path, a type of a test scenario for the function path.

The above information processing apparatus and its units can perform, for example, the method for constructing a test scenario described above with reference to FIGS. 1 to 7 and operations and/or processing of each step thereof, and achieve similar effects, which are not described here.

The information processing apparatus according to the embodiment of the present disclosure is described above with reference to FIG. 8.

An information processing device is provided according to another aspect of the present disclosure. The information processing device may implement the method for constructing a test scenario according to the embodiment of the present disclosure. The information processing device may include a processor. The processor is configured to: construct an invocation relationship graph for functions included in a plurality of executable applications for a target application, where the target application is executed through the plurality of executable applications on distributed nodes in an asynchronous manner; determine, according to a code structure of each function in the invocation relationship graph, one or more of a plurality of risk types which may cause an operation error, for the function; traverse the invocation relationship graph to obtain all possible function paths and determine, based on risk types of functions in each function path, risk types of the function path; and determine, according to risk types of each function path, a type of a test scenario for the function path.

The processor of the information processing device may be configured, for example, to perform the method for constructing a test scenario described above with reference to FIGS. 1 to 7 and operations and/or processing of each step thereof, and functions of the information processing apparatus and each unit thereof described above with reference to FIG. 8, and achieve similar effects, which are not described here.

For example, the type of the test scenario may include: a test scenario simulating execution of the application on one node for one time, a test scenario simulating execution of concurrent operations by multiple users on the application on one node, a test scenario simulating simultaneous execution of the application on multiple nodes for one time, and a test scenario simulating execution of concurrent operations by multiple users on the application on multiple nodes.

In an example, the executable applications may be smart contracts in a blockchain. The plurality of distributed nodes may be a plurality of endorsing nodes in the blockchain.

In a preferred embodiment, the plurality of risk types may include a risk of a function including an operation that generates an uncertain result or calls external resources, and the type of the test scenario determined with respect to the risk may include a test scenario simulating simultaneous execution of the application on multiple nodes for one time.

Optionally, in the test scenario of simulating simultaneous execution of the application on multiple nodes for one time, firstly, the plurality of endorsing nodes simultaneously execute the smart contract with a first endorsing policy for one time, and then, the plurality of endorsing nodes simultaneously execute the smart contract with a second endorsing policy for one time.

In a preferred embodiment, the constructing the invocation relationship graph may include constructing an invocation relationship graph for functions included in smart contracts of the whole blockchain. The plurality of risk types include a risk of a function reading a variable written by itself or calling a function of another smart contract. The type of the test scenario determined with respect to the risk may include a test scenario simulating execution of the smart contract on one endorsing node for one time.

In a preferred embodiment, the plurality of risk types may include a risk of a function including a write operation on a distributed database. The type of the test scenario determined with respect to the risk may include a test scenario simulating execution of concurrent operations by multiple users on the application on multiple nodes.

Optionally, in the test scenario of simulating execution of concurrent operations by multiple users on the application on multiple nodes, the multiple nodes involve different network latencies.

In a preferred embodiment, the plurality of risk types may include a risk of a function including an operation of updating, in a batch processing manner, values of a plurality of variables that are obtained through a query, and the type of the test scenario determined with respect to the risk may include a test scenario simulating execution of concurrent operations by multiple users on the application on one node.

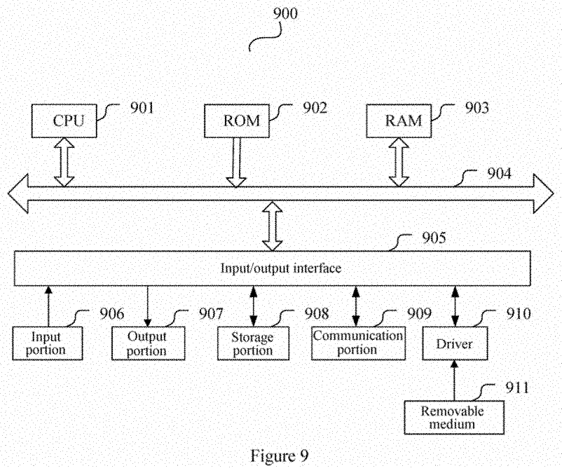

FIG. 9 is a structural diagram showing a possible hardware configuration 900 that may be used for implementing the method for constructing a test scenario, the information processing apparatus, and the information processing device according to the embodiments of the present disclosure.

In FIG. 9, a central processing unit (CPU) 901 performs various processing in accordance with a program stored in a read only memory (ROM) 902 or a program loaded from a storage portion 908 to a random-access memory (RAM) 903. Data required for the various processing of the CPU 901 may be stored in the RAM 903 as needed. The CPU 901, the ROM 902, and the RAM 903 are connected to each other via a bus 904. An input/output interface 905 is also connected to the bus 904.

The following components are connected to the input/output interface 905: an input portion 906 (including a keyboard, a mouse or the like), an output portion 907 (including a display such as a cathode ray tube (CRT), a liquid crystal display (LCD), a loudspeaker or the like), a storage portion 908 (including a hard disk or the like), and a communication portion 909 (including a network interface card such as a LAN card, a modem or the like). The communication portion 909 performs communication processing via a network such as the Internet. A driver 910 may also be connected to the input/output interface 905 as needed. A removable medium 911 such as a magnetic disk, an optical disk, a magneto-optical disk, a semiconductor memory may be installed on the driver 910 as needed, so that a computer program read from the removable medium 911 is installed into the storage portion 908 as needed.

In addition, a program product that stores a machine-readable instruction code is further provided according to the present disclosure. The instruction code, when being read and executed by a machine, performs the method for constructing a test scenario according to the embodiment of the present disclosure. Accordingly, various storage media such as a magnetic disk, an optical disk, a magneto-optical disk, and a semiconductor memory for carrying the program product are also included in the present disclosure.

That is, a storage medium that stores a machine-readable instruction code is further provided according to the present disclosure. The instruction code, when being read and executed by a machine, causes the machine to execute the above method for constructing a test scenario according to the embodiment of the present disclosure. The instruction code includes an instruction code portion for performing the following operations: constructing an invocation relationship graph for functions included in the application; determining, according to a code structure of each function in the invocation relationship graph, one or more of a plurality of risk types which may cause an operation error, for the function; traversing the invocation relationship graph to obtain all possible function paths and determining, based on risk types of functions in each function path, risk types of the function path; and determining, according to risk types of each function path, a type of a test scenario for the function path.

The above storage medium may include, but is not limited to, a magnetic disk, an optical disk, a magneto-optical disk, a semiconductor memory and the like.

In the above description of specific embodiments of the present disclosure, the features described and/or illustrated for one embodiment may be used in the same or similar manner in one or more other embodiments, combined with features in other embodiments or replace features in other embodiments.

In addition, the methods according to the embodiments of the present disclosure are not limited to being performed in the chronological order described in the specification or shown in the drawings, but may also be performed in other chronological order, in parallel, or independently. Therefore, the performing order of the methods described in this specification does not limit the technical scope of the present disclosure.

In addition, it is apparent that each operation process of the above method according to the present disclosure may be implemented in the form of a computer-executable program stored in various machine-readable storage media.

Moreover, the object of the present disclosure may be achieved by directly or indirectly providing a storage medium storing the executable program code described above to a system or device. A computer or a central processing unit (CPU) in the system or device reads and executes the above program code.

In this case, as long as the system or device has a function of executing a program, the embodiments of the present disclosure are not limited to the program. The program may also be in any form, for example, a target program, a program executed by an interpreter, or a script program provided to an operating system.

These above machine-readable storage media include but are not limited to, various memories and storage units, semiconductor devices, magnetic disk units such as optical disks, magnetic disks, and magneto-optical disks, and other media for storing information.

In addition, a client information processing terminal may implement the embodiments of the present disclosure by connecting to a corresponding web site on the Internet and downloading and installing the computer program code according to the present disclosure into the information processing terminal and then executing the program.

In summary, the following solutions are provided according to the embodiments of the present disclosure, but are not limited thereto: According to an example, a method for constructing a test scenario for a target application which is executed through a plurality of executable applications in distributed nodes in an asynchronous manner, including: constructing an invocation relationship graph for functions included in the plurality of executable applications; determining, according to a code structure of each function in the invocation relationship graph, one or more of a plurality of risk types which may cause an operation error, for the function; traversing the invocation relationship graph to obtain all possible function paths and determining, based on risk types of functions in each function path, risk types of the function path; and determining, according to risk types of each function path, a type of a test scenario for the function path.

The type of the test scenario includes: a test scenario simulating execution of the application on one node for one time, a test scenario simulating execution of concurrent operations by multiple users on the application on one node, a test scenario simulating simultaneous execution of the application on multiple nodes for one time, and a test scenario simulating execution of concurrent operations by multiple users on the application on multiple nodes.

The executable applications are smart contracts in a blockchain, and the plurality of distributed nodes are a plurality of endorsing nodes in the blockchain.

The plurality of risk types include a risk of a function including an operation that generates an uncertain result or calls external resources, and the type of the test scenario determined with respect to the risk includes simulating simultaneous execution of the application on multiple nodes for one time.

In the test scenario of simulating simultaneous execution of the application on multiple nodes for one time, firstly, the plurality of endorsing nodes simultaneously execute the smart contract with a first endorsing policy for one time, and then, the plurality of endorsing nodes simultaneously execute the smart contract with a second endorsing policy for one time.

The constructing the invocation relationship graph includes constructing an invocation relationship graph for functions included in smart contracts of the whole blockchain, the plurality of risk types include a risk of a function reading a variable written by itself or calling a function of another smart contract, and the type of the test scenario determined with respect to the risk includes a test scenario simulating execution of the smart contract on one endorsing node for one time.

The plurality of risk types include a risk of a function including a write operation on a distributed database, and the type of the test scenario determined with respect to the risk includes a test scenario simulating execution of concurrent operations by multiple users on the application on multiple nodes.

In the test scenario of simulating execution of concurrent operations by multiple users on the application on multiple nodes, the multiple nodes involve different network latencies.

The plurality of risk types include a risk of a function including an operation of updating, in a batch processing manner, values of a plurality of variables that are obtained through a query, and the type of the test scenario determined with respect to the risk includes a test scenario simulating execution of concurrent operations by multiple users on the application on one node.

According to an example, an information processing device is provided including: a processor configured to: construct an invocation relationship graph for functions included in a plurality of executable applications for a target application, where the target application is executed through the plurality of executable applications on distributed nodes in an asynchronous manner; determine, according to a code structure of each function in the invocation relationship graph, one or more of a plurality of risk types which may cause an operation error, for the function; traverse the invocation relationship graph to obtain all possible function paths and determine, based on risk types of functions in each function path, risk types of the function path; and determine, according to risk types of each function path, a type of a test scenario for the function path.

The type of the test scenario includes: a test scenario simulating execution of the application on one node for one time, a test scenario simulating execution of concurrent operations by multiple users on the application on one node, a test scenario simulating simultaneous execution of the application on multiple nodes for one time, and a test scenario simulating execution of concurrent operations by multiple users on the application on multiple nodes.

The executable applications are smart contracts in a blockchain, and the plurality of distributed nodes are a plurality of endorsing nodes in the blockchain.

The plurality of risk types include a risk of a function including an operation that generates an uncertain result or calls external resources, and the type of the test scenario determined with respect to the risk includes a test scenario simulating simultaneous execution of the application on multiple nodes for one time.

In the test scenario of simulating simultaneous execution of the application on multiple nodes for one time, firstly, the plurality of endorsing nodes simultaneously execute the smart contract with a first endorsing policy for one time, and then, the plurality of endorsing nodes simultaneously execute the smart contract with a second endorsing policy for one time.

The constructing the invocation relationship graph includes constructing an invocation relationship graph for functions included in smart contracts of the whole blockchain, the plurality of risk types include a risk of a function reading a variable written by itself or calling a function of another smart contract, and the type of the test scenario determined with respect to the risk includes a test scenario simulating execution of the smart contract on one endorsing node for one time.

The plurality of risk types include a risk of a function including a write operation on a distributed database, and the type of the test scenario determined with respect to the risk includes a test scenario simulating execution of concurrent operations by multiple users on the application on multiple nodes.

In the test scenario of simulating execution of concurrent operations by multiple users on the application on multiple nodes, the multiple nodes involve different network latencies.

The plurality of risk types include a risk of a function including an operation of updating, in a batch processing manner, values of a plurality of variables that are obtained through a query, and the type of the test scenario determined with respect to the risk includes a test scenario simulating execution of concurrent operations by multiple users on the application on one node.

According to an example, a storage medium storing a machine-readable instruction code that, when being read and executed by a machine, causes the machine to execute a method for constructing a test scenario for a target application which is executed through a plurality of executable applications in distributed nodes in an asynchronous manner, the method including: constructing an invocation relationship graph for a plurality of functions included in the plurality of executable applications; determining, according to a code structure of each function in the invocation relationship graph, one or more of a plurality of risk types which may cause an operation error, for the function; traversing the invocation relationship graph to obtain all possible function paths and determine, based on risk types of functions in each function path, risk types of the function path; and determining, according to risk types of each function path, a type of a test scenario for the function path.

Finally, it should be further noted that the relationship terminologies such as first, second or the like are only used herein to distinguish one entity or operation from another, rather than to necessitate or imply that the actual relationship or order exists between the entities or operations. Furthermore, terms of “include”, “comprise” or any other variants are intended to be non-exclusive. Therefore, a process, method, article or device including a series of elements includes not only the elements but also other elements that are not enumerated, or also includes the elements inherent for the process, method, article or device. Unless expressively limited otherwise, the statement “comprising (including) one . . . ” does not exclude the case that other similar elements may exist in the process, method, article or device.

Although the present disclosure is disclosed above through specific embodiments of the present disclosure, it should be understood that those skilled in the art can make various modifications, improvements or equivalents to the present disclosure within the spirit and scope of the appended claims. These modifications, improvements or equivalents should also be considered to be included in the protection scope of the present disclosure.

1. A method for a computer to construct a test scenario for a target application which is executed through a plurality of executable applications in distributed nodes in an asynchronous manner, the method including:
constructing an invocation relationship graph representing a plurality of functions included in the plurality of executable applications;
determining, according to a code structure of each function of the plurality of functions in the invocation relationship graph, one or more of a plurality of risk types which may cause an operation error for the function;
traversing the invocation relationship graph to obtain possible function paths among the functions and determining, based on a plurality of risk types of functions in each function path of the possible function paths, risk types of the function path; and
determining, according to the risk types of the function path, a type of a test scenario for the function path.

2. The method according to claim 1, wherein the type of the test scenario includes any one or a combination of test scenarios including:
a test scenario simulating execution of one or more of the executable applications on one node among the distributed nodes for one time,
a test scenario simulating execution of concurrent operations by multiple users on one or more of the executable applications on one node among the distributed nodes ,
simulating simultaneous execution of one or more of the executable applications on multiple nodes among the distributed nodes for one time, and
a test scenario simulating execution of concurrent operations by multiple users on one or more of the executable applications on multiple nodes among the distributed nodes.

3. The method according to claim 2, wherein the executable applications are smart contracts in a blockchain, and the plurality of distributed nodes are a plurality of endorsing nodes in the blockchain.

4. The method according to claim 1, wherein
the plurality of risk types include a risk of the function including an operation that generates an uncertain result or calls external resources, and
the type of the test scenario determined with respect to the risk includes a test scenario simulating simultaneous execution of one or more of the executable applications on multiple nodes among the distributed nodes for one time.

5. The method according to claim 3, wherein
in the test scenario of simulating simultaneous execution of one or more of the executable applications on multiple nodes for one time, firstly, the plurality of endorsing nodes simultaneously execute one or more of the smart contacts with a first endorsing policy for one time, and then, the plurality of endorsing nodes simultaneously execute said one or more of the smart contacts with a second endorsing policy for one time.

6. The method according to claim 3, wherein
the constructed invocation relationship graph represents functions included in the smart contracts of the blockchain,
the plurality of risk types include a risk of a function among the functions of a smart contract of reading a variable written by the function itself or calling a function of another smart contract, and the type of the test scenario determined with respect to the risk includes the test scenario simulating execution of the smart contract on one endorsing node among the endorsing nodes for one time.

7. The method according to claim 1, wherein
the plurality of risk types include a risk of the function including a write operation on a distributed database, and
the type of the test scenario determined with respect to the risk includes a test scenario simulating execution of concurrent operations by multiple users on one or more of the executable applications on multiple nodes among the distributed nodes.

8. The method according to claim 7, wherein
in the test scenario of simulating execution of concurrent operations by multiple users on one or more of the executable applications on multiple nodes among the distributed nodes, the multiple nodes involve different network latencies.

9. The method according to claim 1, wherein
the plurality of risk types include a risk of the function including an operation of updating, in a batch processing manner, values of a plurality of variables that are obtained through a query, and
the type of the test scenario determined with respect to the risk includes a test scenario simulating execution of concurrent operations by multiple users on one or more of the executable applications on one node among the distributed nodes.

10. An information processing device, including:
a processor configured to,
construct an invocation relationship graph representing a plurality of functions included in a plurality of executable applications for a target application, wherein the target application is executed through the plurality of executable applications in distributed nodes in an asynchronous manner;
determine, according to a code structure of each function of the plurality of functions in the invocation relationship graph, one or more of a plurality of risk types which may cause an operation error for the function;
traverse the invocation relationship graph to obtain possible function paths among the functions and determine, based on a plurality of risk types of functions in each function path of the possible function paths, risk types of the function path; and
determine, according to the risk types of the function path, a type of a test scenario for the function path.

11. The information processing device according to claim 10, wherein the type of the test scenario includes any one or a combination of test scenarios including:
a test scenario simulating execution of one or more of the executable applications on one node among the distributed nodes for one time,
a test scenario simulating execution of concurrent operations by multiple users on one or more of the executable applications on one node among the distributed nodes,
simulating simultaneous execution of one or more of the executable applications on multiple nodes among the distributed nodes for one time, and
a test scenario simulating execution of concurrent operations by multiple users on one or more of the executable applications on multiple nodes among the distributed nodes.

12. The information processing device according to claim 11, wherein the executable applications are smart contracts in a blockchain, and the plurality of distributed nodes are a plurality of endorsing nodes in the blockchain.

13. The information processing device according to claim 10, wherein
the plurality of risk types include a risk of the function including an operation that generates an uncertain result or calls external resources, and
the type of the test scenario determined with respect to the risk includes a test scenario simulating simultaneous execution of one or more of the executable applications on multiple nodes among the distributed nodes for one time.

14. The information processing device according to claim 12, wherein
in the test scenario of simulating simultaneous execution of one or more of the executable applications on multiple nodes for one time, firstly, the plurality of endorsing nodes simultaneously execute one or more of the smart contacts with a first endorsing policy for one time, and then, the plurality of endorsing nodes simultaneously execute said one or more of the smart contacts with a second endorsing policy for one time.

15. The information processing device according to claim 12, wherein
the constructed invocation relationship graph represents functions included in the smart contracts of the blockchain,
the plurality of risk types include a risk of a function among the functions of a smart contract of reading a variable written by the function itself or calling a function of another smart contract, and the type of the test scenario determined with respect to the risk includes the test scenario simulating execution of the smart contract on one endorsing node among the endorsing nodes for one time.

16. The information processing device according to claim 10, wherein
the plurality of risk types include a risk of the function including a write operation on a distributed database, and
the type of the test scenario determined with respect to the risk includes a test scenario simulating execution of concurrent operations by multiple users on one or more of the executable applications on multiple nodes among the distributed nodes.

17. The information processing device according to claim 16, wherein
in the test scenario of simulating execution of concurrent operations by multiple users on one or more of the executable applications on multiple nodes among the distributed nodes, the multiple nodes involve different network latencies.

18. The information processing device according to claim 10, wherein
the plurality of risk types include a risk of the function including an operation of updating, in a batch processing manner, values of a plurality of variables that are obtained through a query, and
the type of the test scenario determined with respect to the risk includes a test scenario simulating execution of concurrent operations by multiple users on one or more of the executable applications on one node among the distributed nodes.

19. A storage medium storing a machine-readable instruction code that, when being read and executed by a machine, causes the machine to execute a method for constructing a test scenario for a target application which is executed through a plurality of executable applications in distributed nodes in an asynchronous manner, the method including:
constructing an invocation relationship graph representing a plurality of functions included in the plurality of executable applications;
determining, according to a code structure of each function of the plurality of functions in the invocation relationship graph, one or more of a plurality of risk types which may cause an operation error for the function;
traversing the invocation relationship graph to obtain possible function paths among the functions and determining, based on a plurality of risk types of functions in each function path of the possible function paths, risk types of the function path; and
determining, according to the risk types of the function path, a type of a test scenario for the function path.
